(19) United States
(12) Patent Application Publication
(10) Pub. No.: US 2006/0271662 A1
(43) Pub. Date: Nov. 30, 2006

(54) System and method for enabling group subscription for asynchronous push-based applications on a wireless device

(76) Inventors: Brindusa Fritsch, Toronto (CA); Viera Bibr, Kilbride (CA); Michael Shenfield, Richmond Hill (CA)

Correspondence Address: Gowling Lafleur Henderson LLP, 2600-1600 Elgin Street, Ottawa, ON, K1P 1C3, CA

(21) Appl. No.: 11/405,591

(22) Filed: Apr. 18, 2006

Related U.S. Application Data
(60) Provisional application No. 60/672,035, filed on Apr. 18, 2005.

(51) Int. Cl. G06F 15/173

(52) U.S. Cl. 709/223

(57) ABSTRACT

A system and method of enabling group subscription for asynchronous push-based applications on wireless devices are provided. The system comprises an application registry, an application repository and an application gateway server including an event sink for communicating between the system and a device. The application gateway server is configured for communication with a back-end service via an event source and including a subscription collection and a subscriber collection. The method comprises the steps of reading a Web service interface, generating a Web service interface therefrom conforming to a notification protocol, creating a notification-based application bundle for the Web service, publishing the notification-based application bundle and creating an event source.

This non-provisional application claims benefit to U.S. Provisional Application No. 60/672,035 filed Apr. 18, 2005, which is hereby incorporated by reference.

The present patent disclosure relates generally to a communication system for providing communication with a plurality of wireless devices and specifically to a system and method for enabling group subscription for asynchronous push-based applications on such devices.

### BACKGROUND

Due to the proliferation of wireless networks, there are a continually increasing number of wireless devices in use today. These devices include mobile telephones, personal digital assistants (PDAs) with wireless communication capabilities, two-way pagers and the like. Concurrently with the increase of available wireless devices, software applications running on such devices have increased their utility. For example, the wireless device may include an application that retrieves a weather report for a list of desired cities or an application that allows a user to shop for groceries. These software applications take advantage of the ability to transmit data of the wireless network in order to provide timely and useful services to users, often in addition to voice communication. However, due to a plethora of different types of devices, restricted resources of some devices, and complexity of delivering large amounts of data to the devices, developing software applications remains a difficult and time-consuming task.

Currently, devices are configured to communicate with Web services through Internet-based browsers and/or native applications. Browsers have the advantage of being adaptable to operate on a cross-platform basis for a variety of different devices, but have a disadvantage of requesting pages (screen definitions in HTML) from the Web service, which hinders the persistence of data contained in the screens. A further disadvantage of browsers is that the screens are rendered at runtime, which can be resource-intensive. Applications for browsers are efficient tools for designing platform independent applications. Accordingly, different runtime environments, regardless of the platform, execute the same application. However, since different wireless devices have different capabilities and form factors, the application may not be executed or displayed as desired. Further, browser-based application often require significant transfer bandwidth to operate efficiently, which may be costly or even unavailable for some wireless devices.

Current push applications available for mobile devices are proprietary implementations that have not been constructed using a standard specification for the subscription/notification model. Currently there is no known framework to build a mobile application generically, describe it as a ‘notification enabled’ application by pinpointing the notification components and put it in a context from which it can be available to the device for download and point and click execution.

### BRIEF DESCRIPTION OF THE DRAWINGS

An embodiment of the patent disclosure will now be described by way of example only with reference to the following drawings in which:

FIG. 1 shows in a schematic diagram an example of a network facilitating wireless component applications;

FIG. 2 shows in a detailed component diagram an example of the application gateway shown in FIG. 1;

FIG. 3 shows in a flow diagram an example of a wireless component application communication model;

FIG. 4 shows in an interface diagram an example of a communication sequence for the wireless component application communication model of FIG. 3;

FIG. 5 shows in flow diagram an example of a network as shown in FIG. 1 for enabling asynchronous push-based applications on wireless devices in accordance with an embodiment of the present patent disclosure;

FIG. 6 illustrates in a flow diagram an example of subscription in a network configured for group subscription to notification-based applications in accordance with an embodiment of the present patent disclosure;

FIG. 7 illustrates in a flow diagram an example of notification in a network configured for group subscription to notification-based applications in accordance with an embodiment of the present patent disclosure;

FIG. 8 illustrates in a flow diagram an example of un-subscription in a network configured for group subscription to notification-based applications in accordance with an embodiment of the present patent disclosure; and

FIG. 9 illustrates in a flow diagram an example of subscription ending in a network configured for group subscription to notification-based applications in accordance with an embodiment of the present patent disclosure.

### DETAILED DESCRIPTION OF THE PREFERRED EMBODIMENT

Systems and methods disclosed herein provide a communication system for enabling group subscription for asynchronous push-based applications on wireless devices and notification broadcast to obviate or mitigate at least some of the aforementioned disadvantages.

In accordance with an aspect of the present patent disclosure there is provided a system for enabling group subscription for asynchronous push-based applications on wireless devices. The system comprises an application registry, an application repository and an application gateway server including an event sink for communicating between the system and a device. The application gateway server is configured for communication with a back-end service via an event source and including a subscription collection and a subscriber collection.

In accordance with another aspect of the present patent disclosure there is provided a method of enabling group subscription for asynchronous push-based applications on wireless devices. The method comprises the steps of reading a Web service interface, generating a Web service interface therefrom conforming to a notification protocol, creating a notification-based application bundle for the Web service, publishing the notification-based application bundle and creating an event source.

In accordance with another aspect of the present patent disclosure there is provided a computer-readable medium storing instructions or statements for use in the execution in a computer of a method of enabling group subscription for asynchronous push-based applications on wireless devices. The method comprises the steps of reading a Web service interface, generating a Web service interface therefrom conforming to a notification protocol, creating a notification-based application bundle for the Web service, publishing the notification-based application bundle and creating an event source.

In accordance with another aspect of the present patent disclosure there is provided a propagated signal carrier carrying signals containing computer-executable instructions that can be read and executed by a computer. The computer-executable instructions are used to execute a method of enabling group subscription for asynchronous push-based applications on wireless devices. The method comprises the steps of reading a Web service interface, generating a Web service interface therefrom conforming to a notification protocol, creating a notification-based application bundle for the Web service, publishing the notification-based application bundle and creating an event source.

In the wireless device world, where resources are scarce and connectivity is intermittent, the user experience is best when information is ‘pushed’ to the user's device. The user does not experience network latency since the user is not actively requesting the information, but rather the information is pushed to him as soon as it is available. Applications that are suitable for push deliver dynamic data, information that is valuable in real-time (examples include email, messaging, weather, news, stock quotes, sports events, and schedules).

This patent disclosure describes a way to optimize traffic between device and event source for push-enabled applications. A proxy (in wireless component application terms this is the Application Gateway) sends a subscription to the event source on behalf of multiple devices (on some external event like administrator action). This subscription contains criteria that apply for multiple devices, thus reducing wireless traffic (saving each device from the need to subscribe individually with the same criteria). The proxy maintains the list of devices and applications that the subscription applies to. Traffic between event source and proxy is reduced as well, since the event source will only notify the proxy once and then the proxy will notify all subscribers for that subscription.

The method and system enables broadcast of notifications to multiple devices, while the devices are running same or different notification-based applications. This solution greatly optimizes the traffic between server proxy and event source by reducing the number of subscriptions and notifications initiated between the two parties.

Advantageously, the concept of a publish-subscribe mechanism is applied to reduce network traffic and associate through subscriptions disparate mobile applications without any apparent connections between them.

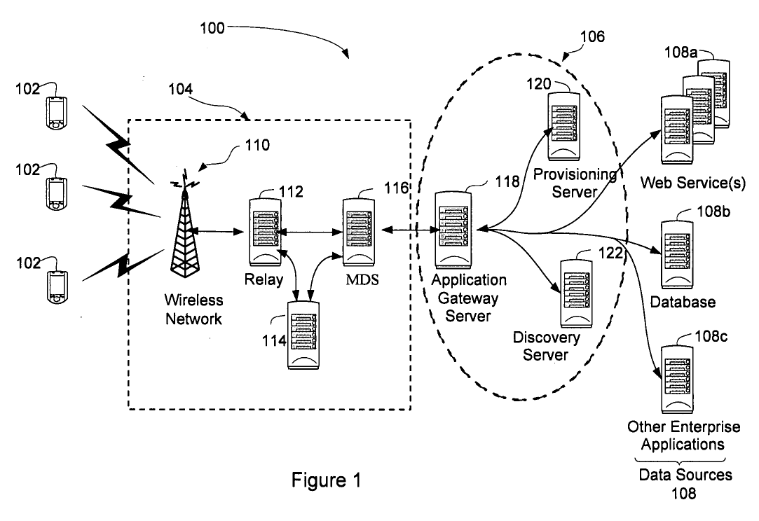

For convenience, like numerals in the description refer to like structures in the drawings. Referring to FIG. 1, a communication infrastructure is illustrated generally by numeral 100. The communication infrastructure 100 comprises a plurality of wireless devices 102, a communication network 104, an application gateway 106, and a plurality of back-end services 108.

The wireless devices 102 are typically personal digital assistants (PDAs), such as a BlackBerry™ by Research in Motion for example, but may include other devices. Each of the wireless devices 102 includes a runtime environment capable of hosting a plurality of component applications.

Component applications comprise one or more data components, presentation components, and/or message components, which are written in a structured definition language such as Extensible Markup Language (XML). The component applications can further comprise workflow components which contain a series of instructions such as written in a subset of ECMAScript, and can be embedded in the XML in some implementations. Therefore, since the applications are compartmentalized, a common application can be written for multiple devices by providing corresponding presentation components without having to rewrite the other components. Further, large portions of the responsibility of typical applications are transferred to the runtime environment for component application. The details of the component applications are described at the end of this description.

The wireless devices 102 are in communication with the application gateway 106 via the communication network 104. Accordingly, the communication network 104 may include several components such as a wireless network 110, a relay 112, a corporate server 114 and/or a mobile data server (MDS) 116 for relaying data between the wireless devices 102 and the application gateway 106.

The application gateway 106 comprises a gateway server 118 a provisioning server 120 and a discovery server 122. The gateway server 118 acts as a message broker between the runtime environment on the wireless devices 102 and the back-end servers 108. The gateway server 118 is in communication with both the provisioning server 120 and the discovery server 122. The gateway server 110 is further in communication with a plurality of the back-end servers 108, such as Web services 108a, database services 108b, as well as other enterprise services 108c, via a suitable link. For example, the gateway server 110 is connected with the Web services 108a and database services 108b via Simple Object Access Protocol (SOAP) and Java Database Connectivity (JDBC) respectively. Other types of back-end servers 108 and their corresponding links will be apparent to a person of ordinary skill in the art.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternatively, if the wireless device 102 is not initially provisioned with the URL and encryption key, they may be pushed to the wireless device 102 via the mobile data server 116. The mobile device 102 can then connect with the application gateway 106 via the URL of the application gateway server 118.

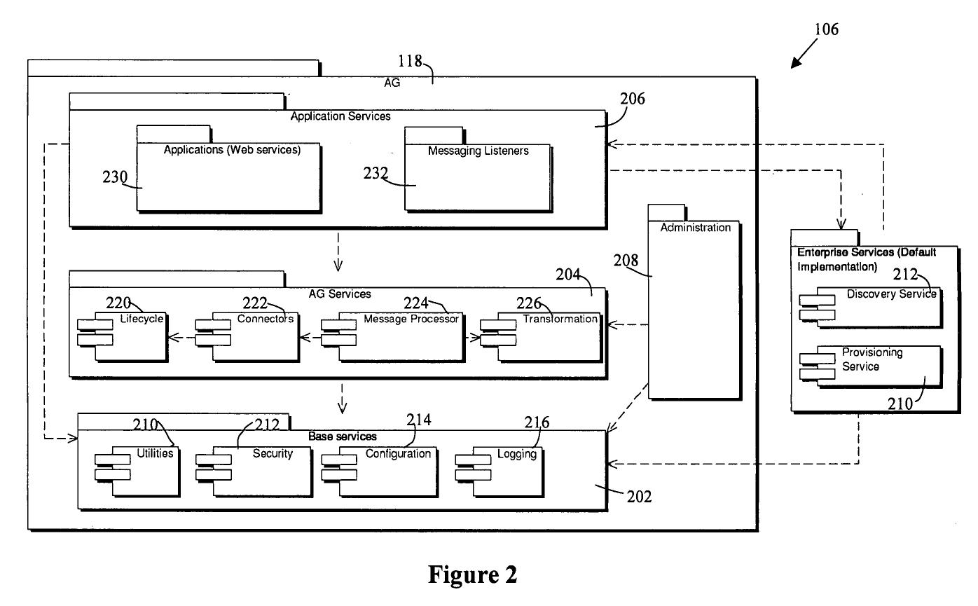

Referring to FIG. 2, a more detailed view of the application gateway 106 is shown. The application gateway server 118 includes three layers of service; a base services layer 202, an application gateway services layer 204 and an application services layer 206. The application gateway server 118 further includes an administration service 208.

The provisioning server 120 and discovery server 122 provide a provisioning service 210 and a discovery service 212, respectively.

At the lowest level, the base services layer 202 offers basic, domain-independent system services to other components in higher levels. Thus, for example, all subsystems in the application gateway services layer 204 and the application services layer 206 can utilize and collaborate with the subsystems in the base services layer 202. In the present embodiment, the base services layer 202 includes a utilities subsystem 210, a security subsystem 212, a configuration subsystem 214, and a logging subsystem 216.

The application gateway services layer 204 provides wireless component application domain-specific services. These services provide efficient message transformation and delivery to back-end services 108 and provide wireless device 102 and component application lifecycle management. In the present embodiment, the application gateway services layer 204 includes a lifecycle subsystem 220, a connector subsystem 222, a messaging subsystem 224, and a transformation subsystem 226.

The application services layer 206 sits at the top of the architecture and provides external program interfaces and user interfaces using subsystems provided by the lower layers. For example, various applications such as a lifecycle application, a packaging application and a message listening application provide external program interfaces since they communicate primarily with applications on external systems. Similarly, an administration application provides a user interface by providing a user with the ability to access and potentially modify application gateway data and/or parameters.

The administration service 208 is responsible for administrative system messages, administration of the wireless devices 102, runtime administration of the application gateway subsystems, support and display system diagnostics, and administration of default implementations of the provisioning and discovery services.

The messaging listening application provides an interface for receiving messages from the wireless devices 102 as well as external sources and forwarding them to the messaging subsystem. Further, the message listening application typically authenticates that the source of the message is valid.

The security subsystem 212 providing services used by other subsystems for securing communications with the wireless device 102. In order to facilitate secure communications, the security subsystem 212 encrypts and decrypts messages, validates signatures and signs messages.

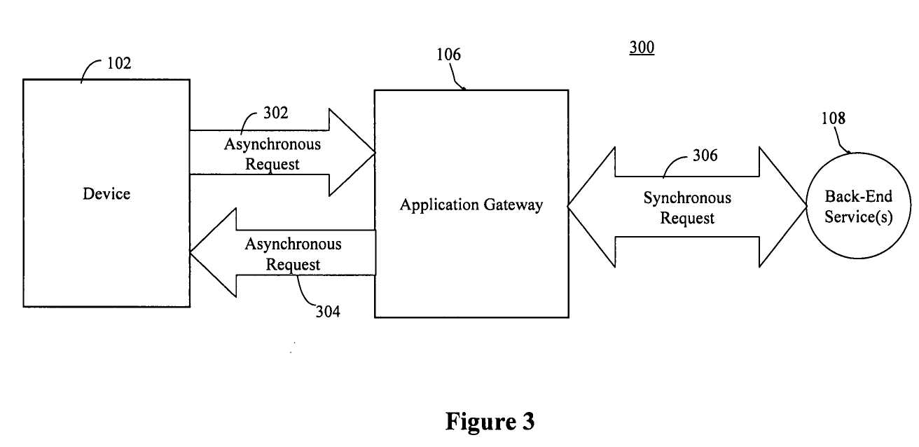

Referring to FIG. 3 there is illustrated in a flow diagram an example of a wireless component application communication model. From a high-level perspective, the overall wireless component application infrastructure 300 includes a wireless component application runtime environment (Device RE) running on the device 102 and a wireless component application gateway (AG) 106 running on the server 118.

The AG 106 serves as a mediator between a wireless component application (sometimes referred to as application in this disclosure) executed by the RE and one or more back-end services 108 with which the application communicates. Often the back-end service is expected to be a Web service 108a using SOAP over HTTP or HTTPS as the transport protocol. As Web services are the most commonly expected back-end service 108, the term Web service is used interchangeable with back-end service 108 throughout this disclosure. However, it is appreciated that other types of back-end services can also be adapted to the disclosure. FIG. 3 exemplifies a synchronous link with a back-end service 108. However, it should be appreciated that the AG 106 can be in communication with back-end services 108 over asynchronous links.

The wireless component application communication model 300 is based upon an asynchronous messaging paradigm. In this model the application gateway (AG) 106 establishes and mediates the connection between the device 102 and the back-end service(s) 108 to:
1. Achieve greater flexibility in resource management.
2. Provide reliable communication link between device 102 and back-end service 108 to handle situations when wireless coverage is unstable.
3. Efficiently distribute workload between device RE 102 and AG 106.

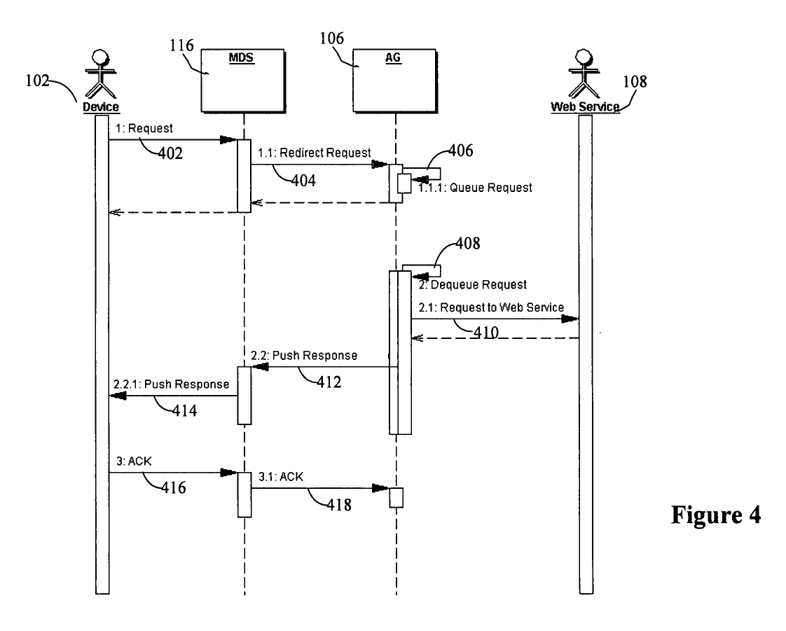

Referring to FIG. 4 there is illustrated in an interface diagram an example of a communication sequence for the wireless component application communication model of FIG. 3. The diagram describes the communications sequence between the device 102 and the back-end service(s) 108:
Upon receiving a request 402 from the device 102, via redirect request 404 the mobile data server (MDS) 116, AG 106 queues the request 406 and releases the connection to the device.
Next, the request is retrieved from the queue 408, pre-processed and forwarded 410 to the Web service 108 through a synchronous communication channel.
Any response from the previous request is processed by the application gateway (AG) 106 and a response message is sent asynchronously 412 and 414 back to the device.

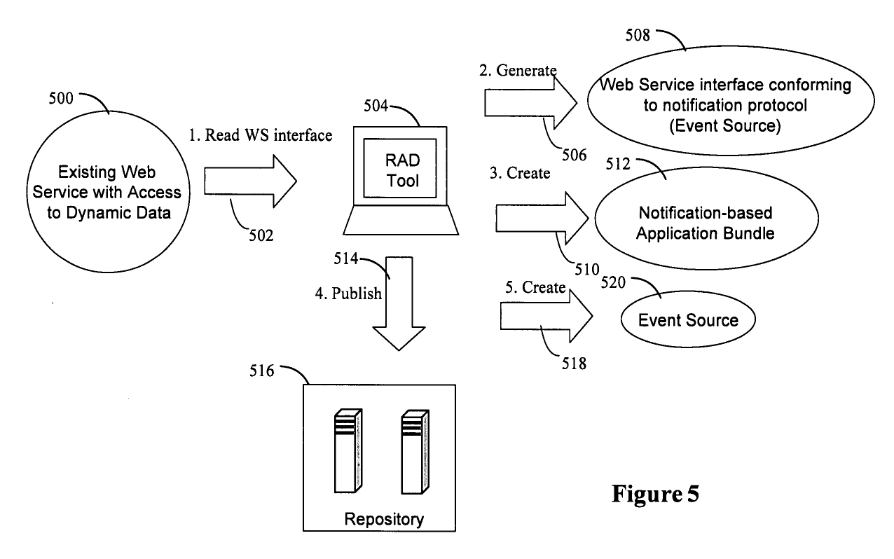

Referring to FIG. 5 there is illustrated in a flow diagram an example of a network as shown in FIG. 1 for enabling asynchronous push-based applications on wireless devices in accordance with an embodiment of the present patent disclosure. In FIG. 5, at Step 1, an existing Web service 500 has its Web service interface read 502 by a user of a (rapid application development) RAD tool 504. Then, at Step 2, the RAD tool user 504 generates 506 a Web service interface 508 conforming to a notification protocol. At Step 3, the RAD tool user 504 creates 510 a notification-based application bundle 512, then at Step 4 publishes 514 the notification-based application bundle 512 to a repository 516 associated with the application gateway 106. At the same time the RAD tool user 504 publishes a registry entry in a registry, the registry entry refers to the application bundle and where it is located. At Step 5 the RAD tool user 504 creates 518 an event source 520. If the mobile application developer (RAD user) has update rights to the back-end server that has the data and is to act as the event source 520, the event source is implemented according to the protocol supported by the application gateway 106. Otherwise, a proxy is created on the application gateway 106 to implement the required subscription/notification protocol. In this implementation of event source 520, the back-end infrastructure is polled for data and to detect data changes and triggers notifications when changes are found.

The following definitions are used with the detailed description:

| | |
|---|---|
| Notification | message carrying data of interest to a specific |
| | user |
| Subscription | message denoting an event originated by a user that |
| | expresses his interest to be notified when specific |
| | events occur |
| Server Proxy | server enabling a mobile application to communicate |
| | with back-end application servers and have access |
| | to data |
| Notification- | XML application built with RAD tools that has been |
| based | built for a framework that supports a notification |
| Application | protocol (for example, WS-Eventing). The |
| Bundle | application is accompanied by additional |
| | information to help the mobile framework map the |
| | application messages to notification protocol |
| | components. |
| WS-Eventing | Web Services Eventing standard for notification- |
| | based Web services |
| | (ftp://www6.software.ibm.com/software/developer/ |
| | library/ws-eventing/WS-Eventing.pdf) |
| Event Source | Back-end server accepting subscriptions, delivering |
| | notifications based on them and terminating |
| | subscriptions |
| Event Sink | Server accepting notifications from event source |
| Filter | Expression that describes the type of data the user is |
| | interested in; it may have any format as long as the |
| | event sink and the event source both understand it |

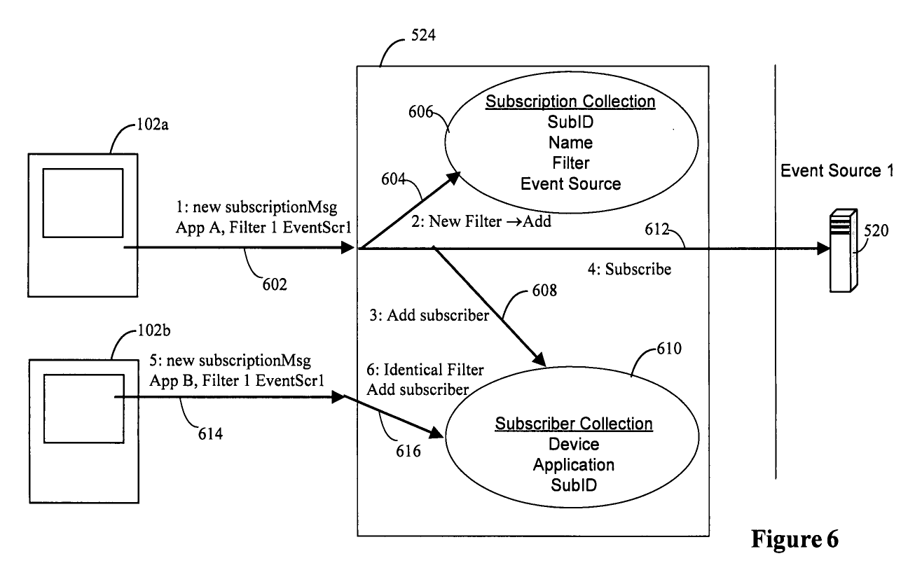

Referring to FIG. 6 there is illustrated in a flow diagram an example of subscription in a network configured for group subscription to notification-based applications in accordance with an embodiment of the present patent disclosure. Two mobile devices 102a and 102b communicate separately with a server proxy 524 to subscribe to services provided by the event source 520. At Step 1 the mobile device 102a sends a new subscription message 602 to the server proxy 524.

The server proxy 524 determines whether a subscription message with the same filter content and destination (event source endpoint) has been previously received and stored in the subscription collection. If a subscription matching this criteria is not found as shown at Step 2, a new filter is added 604 to a subscription collection 606 and at Step 3 a subscriber is added 608 to a subscriber collection 610. At Step 4, a subscribe message is sent 612 to the event source 520. If the subscription matching the criteria is found (yes) as shown at Steps 5 and 6 only information for a new subscriber 102b is preserved at 614 and 616 in the subscriber collection.

Subscribe Use Case: Devicel (102a) sends 602 the subscription SA with Filter 1. At the server proxy 524, Filter1 is assembled in accordance with the filter expression used by the event source 520 (or protocol) to form for example, “P1”+“P2”+“P3”. This subscription is sent to event source 1 (520). At some other time, Device2 (102b) sends 614 another subscription for another application B that has the same Filter1 and is intended for the same event source 520. Since these two subscriptions have identical parameters, bandwidth savings can be realized by only sending the subscription once 612 to the event source 520. In other words, if any identical subscriptions occur, the proxy only preserves 616 the identity of the subscriber (in this case device and application).

The following are examples of two devices subscribing to two different applications that have common filter parameter values:

Device1
Application A

Subscription SA

Filter1

P1
P2
P3

Device2
Application B

Subscription SB

Filter1

P1
P2
P3

The following other scenarios can occur where the same subscription is applied:

(Filter1, E1), D1, App A—Subscription sent from Device D1 (102a), application A, with Filter1 for event source E1 (520)

(Filter1, E1), D2, App A

(Filter1, E1), D1, App B

(Filter1, E1), D3, App B

The server proxy 524 maintains a subscription collection 606 including the following:
Subscription Internal ID—The Subscription internal ID is generated by the proxy server 524 and sent to the event source 520; it is used by the event source 520 for notifications and subscription end.
Subscription External ID (or Cancellation ID)—The Subscription external ID is sent by the event source 520 in subscription response; it is used by the proxy server 524 to send an unsubscribe message to the event source 520 (i.e., to cancel the subscription).
Subscription Name is unique across an application or within a subscription type. The Subscription name is sent by the device 102.
Filter expression is sent by device 102; expression is assembled by the server proxy 524.
Event Source Endpoint—the server proxy 524 loads connectivity information for the event source endpoint when an application is installed on device 102.

The server proxy 524 maintains a subscriber collection 610 with a reference to the subscription ID including the following:
Device
Application
Expiry (optional)—Expiry: date when subscription for this subscriber will expire; if expiry is specified, the proxy has to consider it and delete subscribers after this time is elapsed
Subscription Internal ID is reference to subscription collection
Subscription name is the unique identifier on the device; it is used for notification, unsubscribe, subscription end.

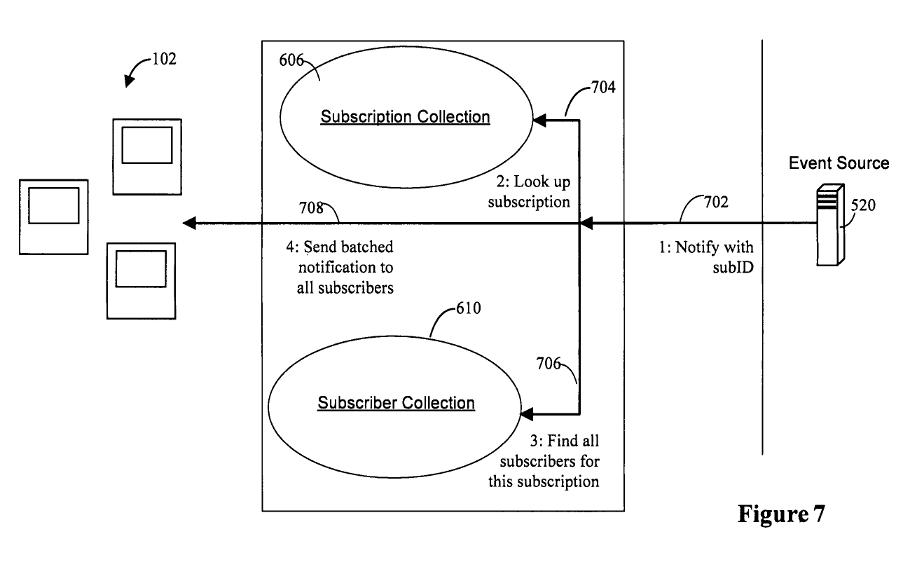

Referring to FIG. 7 there is illustrated in a flow diagram an example of notification in a network configured for group subscription and notification broadcast to notification-based applications in accordance with an embodiment of the present patent disclosure.

When notification 702 for the subscription arrives at Step 1, the server proxy 524 looks up 704 the subscription at Step 2 and finds 706 all the subscribers for the ‘service’ at Step 3 and broadcasts 708 the message to all of them 102 at Step 4. The subscriber is represented by a (device, application) pair. The server proxy 524 builds and sends this message to different mobile applications hosted by the runtime environment on the mobile device.

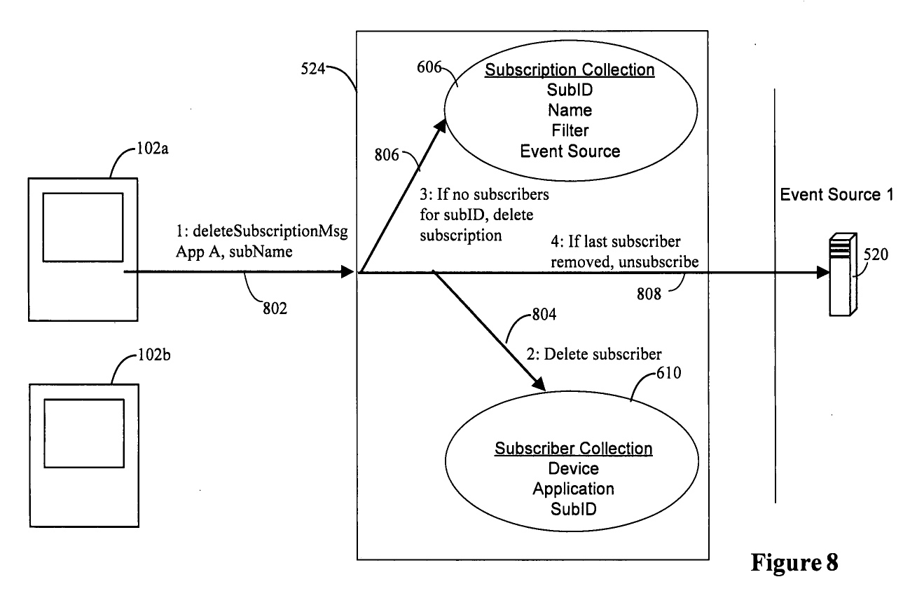

Referring to FIG. 8 there is illustrated in a flow diagram and example of un-subscription in a network configured for group subscription to notification-based applications in accordance with an embodiment of the present patent disclosure. An unsubscribe 802 is initiated by the subscriber 102a, at Step 1. The proxy server removes 804 the subscriber from the subscriber collection 610, at Step 2. Only if there are no longer any instances in the subscriber collection, the subscription identified by the subscription internal ID is removed 806 from the subscription collection 606, at Step 3 and an unsubscribe message is sent 808 to the event source 520, at Step 4.

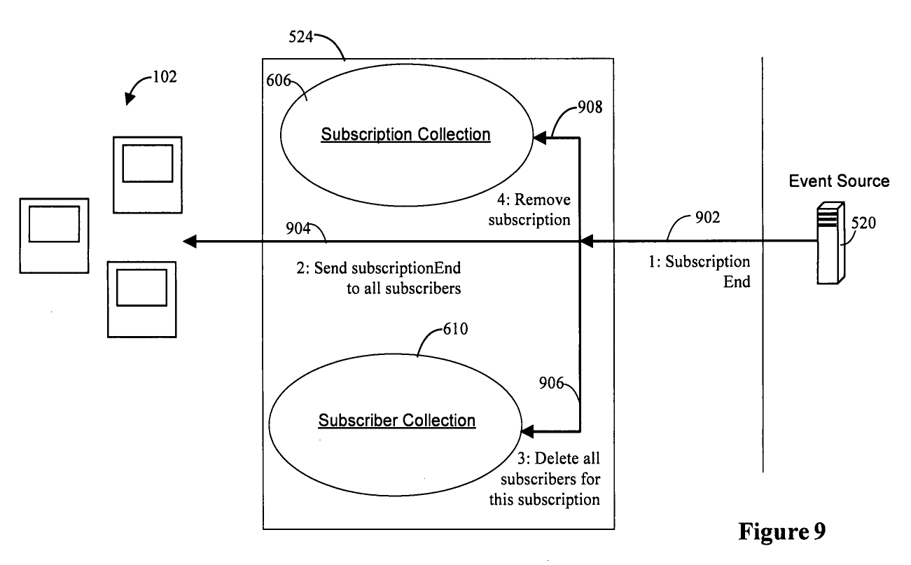

Referring to FIG. 9 there is illustrated in a flow diagram an example of subscription ending in a network configured for group subscription to notification-based applications in accordance with an embodiment of the present patent disclosure. The event source 520 initiates Subscription End 902, at Step 1. When received, the proxy server 524 sends 904 a subscription End message to all subscribers 102 for this subscription ID, at Step 2. Note that the server proxy 524 builds and sends this message to different applications hosted by the same runtime environment. The proxy server 524 empties 906 the subscriber collection 610, at Step 3 and removes 908 the subscription with this ID from the subscription collection 606, at Step 4. The subscriber instance is represented by a (device, application) pair.

The system and methods according to the present patent disclosure may be implemented by any hardware, software or a combination of hardware and software having the above described functions. The software code, either in its entirety or a part thereof, may be stored in a computer-readable memory. Further, a computer data signal representing the software code which may be embedded in a carrier wave may be transmitted via a communication network. Such a computer-readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure.

What is claimed is:

1. A system for enabling group subscription for asynchronous push-based applications on wireless devices, the system comprising:
an application registry;
an application repository; and
an application gateway server including an event sink for communicating between the system and a device, the application gateway server configured for communication with a back-end service via an event source and including a subscription collection and a subscriber collection.

2. The system as claimed in claim 1, wherein the event source is in the back-end service.

3. The system as claimed in claim 1, wherein the event sink is a proxy in the application gateway.

4. The system as claimed in claim 1, wherein the application registry includes an entry for a component application in the application repository.

5. The system as claimed in claim 1, wherein the application repository includes a component application for accessing the back-end service via the event source.

6. The system as claimed in claim 1, wherein the system enables notification message broadcast to multiple subscribers to data content.

7. A method of enabling group subscription for asynchronous push-based applications on wireless devices, the method comprising:
reading a first Web service interface;
generating a second Web service interface therefrom conforming to a notification protocol;
creating a notification-based application bundle for the second Web service;
publishing the notification-based application bundle; and
creating an event source.

8. The method as claimed in claim 7, further comprising the steps of:
creating a subscription collection; and
creating a subscriber collection.

9. The method as claimed in claim 8, wherein the subscriber collection contains a plurality of (device, application) pairs.

10. The method as claimed in claim 8, further comprising the steps of:
receiving a first subscription request having filter content and a destination;
determining if a subscription message having the filter content and destination has been previously received; and
sending a second subscription request if the subscription message has not been previously received.

11. The method as claimed in claim 10, wherein the step of determining comprises the step of comparing the filter content and destination with subscription message data in the subscriber collection.

12. The method as claimed in claim 10, wherein the step of determining comprises the step of comparing the filter content and destination with subscription message information in the subscription collection.

13. The method as claimed in claim 8, further comprising the steps of:
receiving a notification having filter content and a destination from the event source;
comparing the filter content and destination with subscriber information in the subscriber collection; and
sending the notification to subscribers that have the filter content and destination.

14. The method as claimed in claim 8, further comprising the steps of:
receiving a notification having filter content and a destination from the event source;
comparing the filter content and destination with subscriber information in the subscription collection; and
sending the notification to subscribers that have the filter content and destination.

15. The method as claimed in claim 7, wherein the method is executed in a system having:
an application registry;
an application repository; and
an application gateway server including an event sink for communicating between the system and a device, the application gateway server configured for communication with a back-end service via an event source

16. A computer-readable medium storing instructions or statements for use in the execution in a computer of a method of enabling group subscription for asynchronous push-based applications on wireless devices, the method comprising the steps of:
reading a Web service interface;
generating a Web service interface therefrom conforming to a notification protocol;
creating a notification-based application bundle for the Web service;
publishing the notification-based application bundle; and
creating an event source.

17. A propagated signal carrier carrying signals containing computer-executable instructions that can be read and executed by a computer, the computer-executable instructions being used to execute a method of enabling group subscription for asynchronous push-based applications on wireless devices, the method comprising the steps of:
reading a Web service interface;
generating a Web service interface therefrom conforming to a notification protocol;
creating a notification-based application bundle for the Web service;
publishing the notification-based application bundle; and
creating an event source.
